(19) United States
(12) Patent Application Publication
(10) Pub. No.: US 2010/0022237 A1
(43) Pub. Date: Jan. 28, 2010

(54) MULTI-MODE COMMUNICATION SYSTEM

(75) Inventors: Tyler Wallis, San Antonio, TX (US); William S. Robbins, Sun Prairie, WI (US); Larry B. Pearson, San Antonio, TX (US); Anup D. Karnalkar, Allen, TX (US); Mark Ryan, Norcross, GA (US); Susan S. Steele, Alpharetta, GA (US); Jerry O'Leary, Chicago, IL (US)

Correspondence Address: AT&T Legal Department - AS;Attn: Patent Docketing, Room 2A-207, One AT&T Way, Bedminster, NJ, 07921, US

(73) Assignee: AT&T INTELLECTUAL PROPERTY I, L.P., RENO, NV (US)

(21) Appl. No.: 12/181,033

(22) Filed: Jul. 28, 2008

(51) Int. Cl. H04W 4/00; H04B 1/38

(52) U.S. Cl. 455/426.1; 455/573; 370/338

(57) ABSTRACT

A system that incorporates teachings of the present disclosure may include, for example, a communication system having a battery-operated communication device (BOCD) operating according to a Wireless Fidelity (WiFi) access protocol, or a Digital Enhanced Cordless Telecommunications (DECT) wireless access protocol, one or more battery-operated handsets (BOHs) operating according to the DECT wireless access protocol, and a base unit with a Public Switched Telephone Network (PSTN) port and an Ethernet port. The base unit can be adapted to provide voice or data services to the BOCD by way of the PSTN port or the Ethernet port while communicatively coupled thereto according to the DECT wireless access protocol, or the WiFi access protocol, and provide voice services to each of the one or more BOHs by way of the PSTN port while communicatively coupled thereto according to the DECT wireless access protocol. Additional embodiments are disclosed.

### FIELD OF THE DISCLOSURE

The present disclosure relates generally to communication systems and more specifically to multi-mode communication systems.

### BACKGROUND

Battery operated cordless phones provide consumers the flexibility to move about a dwelling while communicating with others over a telephonic system. For data communications, wireless Fidelity (WiFi) access points with Internet access can provide consumers the flexibility to move about a building while connected to the Internet with a portable wireless computer.

### BRIEF DESCRIPTION OF THE DRAWINGS

FIG. 1 depicts illustrative embodiments of a communication device;

FIGS. 2-4 depict illustrative form factors of the communication device of FIG. 1;

FIG. 5 depicts an illustrative embodiment of a communication system;

FIG. 6 depicts an illustrative embodiment of another communication system; and

FIG. 7 depicts an illustrative diagrammatic representation of a machine in the form of a computer system within which a set of instructions, when executed, may cause the machine to perform any one or more of the methodologies discussed herein.

### DETAILED DESCRIPTION

One embodiment of the present disclosure entails a communication system having a battery-operated communication device with a touch-sensitive display. The battery-operated communication device can communicatively operate according to a Wireless Fidelity (WiFi) access protocol, or a Digital Enhanced Cordless Telecommunications (DECT) wireless access protocol. The communication system can further include one or more battery-operated handsets, each communicatively operating according to the DECT wireless access protocol, and a base unit with a Public Switched Telephone Network (PSTN) port and an Ethernet port. The PSTN port can be used for communicatively coupling to another PSTN port of a building, while the Ethernet port can be used for communicatively coupling to another Ethernet port. The base unit can communicatively operate according to the WiFi access protocol, or the DECT wireless access protocol. The base unit can be adapted to provide voice communication services to the battery-operated communication device by way of the PSTN port while communicatively coupled to the battery-operated communication device according to the DECT wireless access protocol, provide data communication services to the battery-operated communication device by way of the Ethernet port while communicatively coupled to the battery-operated communication device according to the WiFi access protocol, and provide voice communication services to each of the one or more battery-operated handsets by way of the PSTN port while communicatively coupled to each of the one or more battery-operated handsets according to the DECT wireless access protocol.

Another embodiment of the present disclosure entails a communication system having a battery-operated communication device with a touch-sensitive display operating according to a WiFi access protocol, or a DECT wireless access protocol, one or more battery-operated handsets, each communicatively operating according to the DECT wireless access protocol, and a base unit comprising a voice services port, a WiFi routing device, and a modem communicatively coupled to the WiFi routing device. The base unit can communicatively operate according to the WiFi access protocol, or the DECT wireless access protocol. The base unit can be adapted to provide voice communication services to the battery-operated communication device by way of the voice services port while communicatively coupled to the battery-operated communication device according to the DECT wireless access protocol, provide data communication services to the battery-operated communication device by way of the modem while communicatively coupled to the battery-operated communication device according to the WiFi access protocol, and provide voice communication services to each of the one or more battery-operated handsets by way of the voice services port while communicatively coupled to the one or more battery-operated handsets according to the DECT wireless access protocol.

Yet another embodiment of the present disclosure entails a communication system having a battery-operated communication device with a touch-sensitive display operating according to a WiFi access protocol, or a DECT wireless access protocol, one or more battery-operated handsets, each communicatively operating according to the DECT wireless access protocol, and a base unit with a voice services port and a data services port operating according to the WiFi access protocol. The base unit can be adapted to provide voice communication services to the battery-operated communication device by way of the voice services port while communicatively coupled to the battery-operated communication device according to the WiFi access protocol, provide data communication services to the battery-operated communication device by way of the data services port while communicatively coupled to the battery-operated communication device according to the WiFi access protocol, and provide voice communication services to each of the one or more battery-operated handsets by way of the battery-operated communication device while the battery-operated communication device is communicatively coupled to the base unit according to the WiFi access protocol and communicatively coupled to each of the one or more battery-operated handsets according to the DECT wireless access protocol.

Another embodiment of the present disclosure entails a method involving distributing a combination of a battery-operated communication device with a touch-sensitive display operating according to a WiFi access protocol, or a DECT wireless access protocol, one or more battery-operated handsets, each communicatively operating according to the DECT wireless access protocol, and a base unit with a voice services port and a data services port. The base unit can be adapted to provide voice communication services to the battery-operated communication device by way of the voice services port while communicatively coupled to the battery-operated communication device according to the DECT wireless access protocol, provide data communication services to the battery-operated communication device by way of the data services port while communicatively coupled to the battery-operated communication device according to the WiFi access protocol, and provide voice communication services to each of the one or more battery-operated handsets by way of the voice services port while communicatively coupled to each of the one or more battery-operated handsets according to the DECT wireless access protocol.

Yet another embodiment of the present disclosure entails a communication system having a battery-operated communication device with a touch-sensitive display communicatively operating according to one or more short-range wireless access protocols, one or more battery-operated handsets, each communicatively operating according to one of the short-range wireless access protocols, and a base unit with a voice services port and a data services port. The base unit can be adapted to provide voice communication services to the battery-operated communication device by way of the voice services port while communicatively coupled to the battery-operated communication device according to one of the short-range wireless access protocols, provide data communication services to the battery-operated communication device by way of the data services port while communicatively coupled to the battery-operated communication device according to the same short-range wireless access protocol or another of the short-range wireless access protocols, and provide voice communication services to each of the one or more battery-operated handsets by way of the voice services port while communicatively coupled to each of the one or more battery-operated handsets according to one of the short-range wireless access protocols.

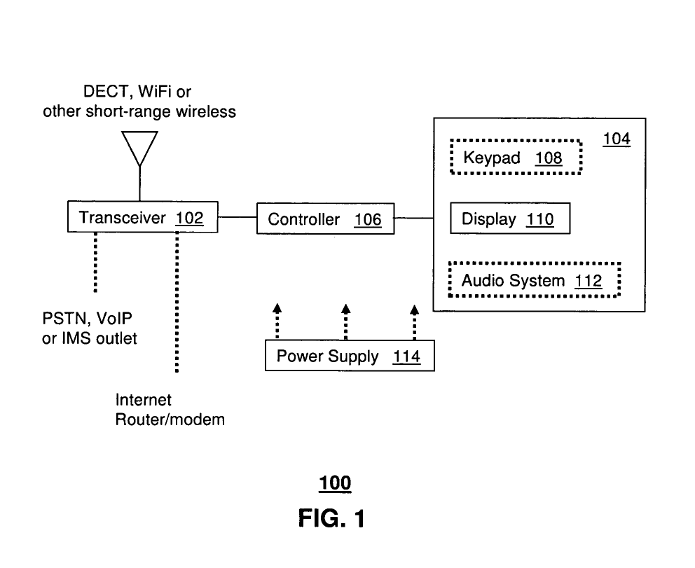

FIG. 1 depicts an exemplary embodiment of a communication device 100. The communication device 100 can comprise a wireline or wireless transceiver 102 (herein transceiver 102), a user interface (UI) 104, a power supply 114, and a controller 106 for managing operations thereof. The transceiver 102 can support short-range wireless access technologies such as a Bluetooth wireless access protocol, a Wireless Fidelity (WiFi) access protocol, a Digital Enhanced Cordless Telecommunications (DECT) wireless access protocol, or other suitable present and next generation short-range wireless access protocols. The transceiver 102 can also support common wireline access technologies such as circuit-switched wireline access technologies, packet-switched wireline access technologies, or combinations thereof. PSTN can represent one of the common circuit-switched wireline access technologies. Voice over Internet Protocol (VoIP), and IP data communications can represent some of the commonly available packet-switched wireline access technologies. The transceiver 102 can also be adapted to support IP Multimedia Subsystem (IMS) protocol for interfacing to an IMS network that can combine PSTN and VoIP communication technologies.

The UI 104 can include a depressible or touch-sensitive keypad 108 and a navigation mechanism such as a roller ball or navigation disk for manipulating operations of the communication device 100. The UI 104 can further include a display 110 such as monochrome or color LCD (Liquid Crystal Display), OLED (Organic Light Emitting Diode) or other suitable display technology for conveying images to the end user of the communication device 100. In an embodiment where the display 110 is touch-sensitive, a portion of the keypad 108 can be presented by way of the display. The UI 104 can also include an audio system 112 that utilizes common audio technology for conveying low volume audio (e.g., audio heard only in the proximity of a human ear) and high volume audio (e.g., speakerphone for hands free operation). The audio system 112 can further include a microphone for intercepting audible signals of an end user.

The power supply 114 can utilize common power management technologies such as replaceable and rechargeable batteries, supply regulation technologies, and charging system technologies for supplying energy to the components of the communication device 100 to facilitate portable applications. The power supply 114 can be coupled to a tethered Direct Current (DC) source such as a transformer for charging the rechargeable batteries by way of a trickle charge. Alternatively, the power supply 114 can be coupled to an inductive charger for untethered charging of the rechargeable batteries. To accomplish this, the charging system of the power supply 114 can be equipped with a coil that can inductively couple to an induction charger for charging purposes.

The controller 106 can utilize computing technologies such as a microprocessor and/or digital signal processor (DSP) with associated storage memory such as Flash, ROM, RAM, SRAM, DRAM or other storage technologies for controlling the components of the communication device 100.

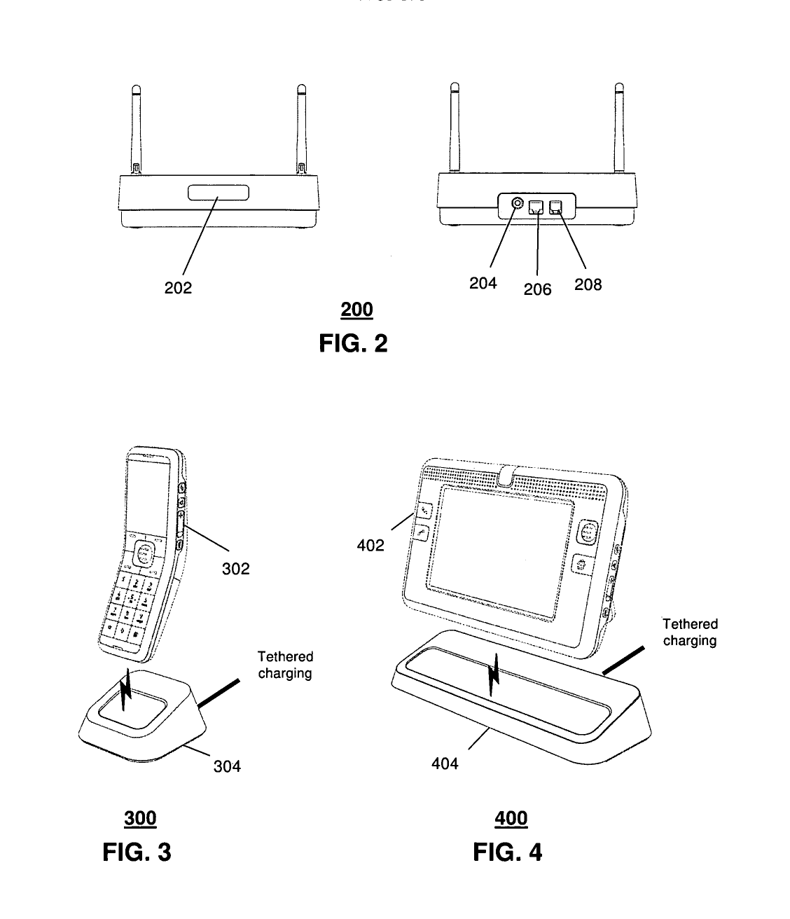

FIGS. 2-4 depict illustrative form factors of the communication device 100 of FIG. 1 utilizing some or all of the components described above for the communication device. FIG. 2 depicts for example a base unit 202 with a port 204 that can be coupled to a power source for powering the base unit, an Ethernet port 206 for coupling to a broadband routing device such as an Internet router/modem, and a PSTN, VoIP or IMS port 208 for coupling to a common PSTN, VoIP or IMS outlet of a building. The base unit 202 can include portions of the communication device 100 such as the tether power supply 114, a simplified UI 104 (e.g., LCD status indicator), a transceiver 102 for communicatively coupling to other communication devices 100 using IP (e.g., Ethernet), WiFi or DECT access technologies, and the controller 106 for managing operations thereof.

FIG. 3 depicts a battery-operated handset 302 and a corresponding cradle charger 304. The handset 302 can include portions of the communication device 100 such as the UI 104, the controller 106, the untethered power supply 114 for portable operation, and the transceiver 102 for communicatively coupling to the base unit 202 according to the DECT wireless access protocol. FIG. 4 depicts a battery-operated touch-sensitive display tablet 402 and a corresponding cradle charger 404. The tablet 402 can include portions of the communication device 100 such as the UI 104 with a touch-sensitive display, the controller 106, the untethered power supply 114 for portable operation, and the transceiver 102 for communicatively coupling to the base unit 202 according to the DECT wireless access protocol, or WiFi wireless access protocol. The charging cradles 304, 404 can be tethered DC trickle chargers, or inductive chargers.

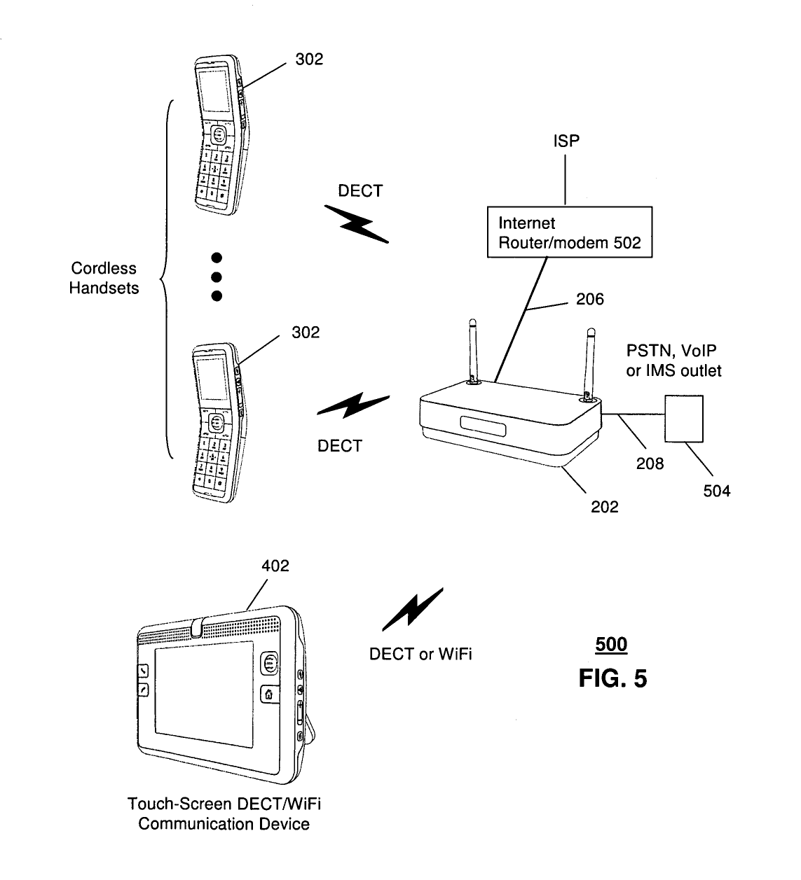

FIG. 5 depicts an illustrative embodiment of a communication system 500 utilizing the communication devices of FIGS. 2-4. In FIG. 5, the battery operated handsets 302 operate as cordless handsets, each communicatively operating according to the DECT wireless access protocol. The tablet 402 communicatively operates according to the WiFi and DECT wireless access protocols. The Ethernet port 206 of the base unit 202 can connect to a common broadband routing device 502 such as a gateway, a network access point, an internet access point, or other suitable routing device communicatively coupled or an integral part of a broadband modem such as cable, or digital subscriber line (xDSL) modem that connects to an Internet Service Provider (ISP) supplying Internet services to a residence or enterprise. The PSTN, VoIP or IMS port 208 of the base unit 202 can connect to a common PSTN, VoIP or IMS outlet of the residence or enterprise for supplying voice services to the handsets 302 or tablet 402.

The base unit 202 can be programmed with software to provide voice communication services to the battery-operated tablet 402 by way of the PSTN, VoIP or IMS port 208 while communicatively coupled to the battery-operated tablet according to the DECT wireless access protocol. The base unit 202 can also be adapted to provide data communication services (such as an Internet connection by way of the ISP) to the battery-operated tablet 402 by way of the Ethernet port 206 while communicatively coupled to the battery-operated tablet according to the WiFi access protocol. The base unit 202 can be further adapted to provide voice communication services to each of the one or more battery-operated handsets 302 by way of the PSTN, VoIP, or IMS port 208 while communicatively coupled to each of the one or more battery-operated handsets according to the DECT wireless access protocol.

In summary, phone calls can be received or initiated from the handsets 302 or the tablet 402 by way of a DECT air interface connecting said devices to the base unit 202 which then provides voice services to said devices over a tethered connection to a PSTN, VoIP or IMS outlet. The tablet 402 can connect to the Internet (or other packet-switched networks) by way of a WiFi air interface connecting the tablet to the base unit 202 which then provides data services to said tablet over a tethered connection to a router/modem externally coupled to the base unit or an integral part thereof.

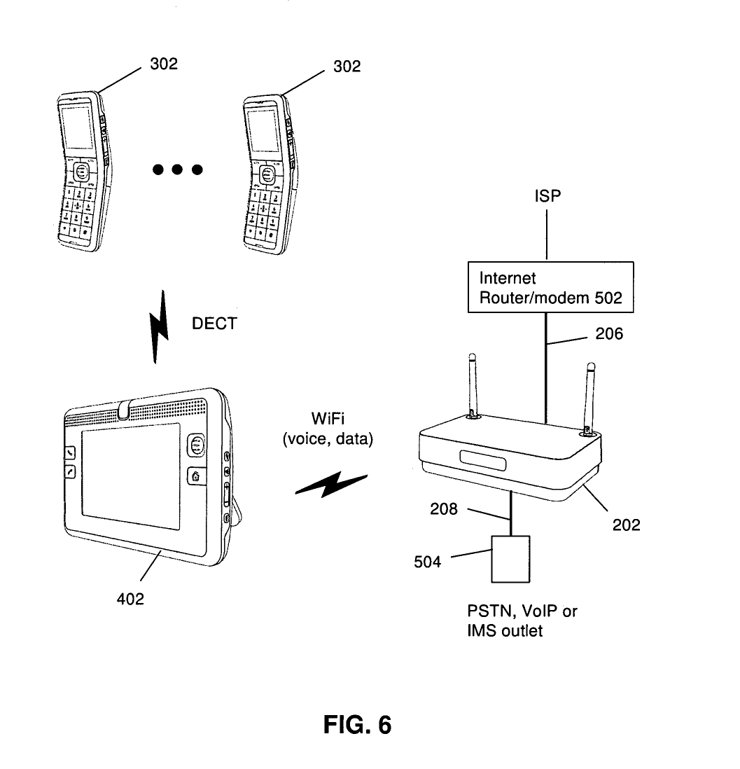

FIG. 6 depicts an illustrative embodiment of another communication system 600 utilizing the communication devices of FIGS. 2-4. In this illustration, the battery operated handsets 302 and tablet 402 operate as cordless DECT devices. The tablet 402, however, serves as a DECT base station for the handsets 302. Accordingly, the DECT base station function of the base unit 202 is transferred to the tablet 402 in this illustrative embodiment. With this transfer, the base unit 202 only supports a WiFi air interface for voice or data communications. The PSTN, VoIP or IMS port 208 of the base unit 202 is connected as in FIG. 5, as is the Ethernet port 206 (assuming an external router/modem 502).

Accordingly, the tablet 402 is adapted to provide PSTN, VoIP or IMS services to the handsets 302 by way of the PSTN, VoIP or IMS port 308 of the base unit 202 while the tablet is communicatively to the handset according to the DECT wireless access protocol and communicatively coupled to the base unit 202 according to the WiFi wireless access protocol. To accomplish these connections, the tablet 402 is adapted to convert utilizing common signal processing techniques voice signals exchanged over a DECT air interface to voice signals exchanged over a WiFi air interface. The tablet 402 can provide Internet data services by way of the Ethernet port 206 while communicatively coupled to the base unit 202 over the WiFi air interface.

The disclosure associated with FIGS. 5-6 provides a number of embodiments for combining the communication devices of FIGS. 2-4 in innovative ways not presently available in prior art systems. The base unit 202 can provide a central means for connecting to common voice and data ports in a dwelling, thereby untethering the handsets 302 and tablet 402 from said ports, and adding flexibility to the placement of the handsets and tablet in the dwelling. All that is needed to enable operation of the handsets 302 and tablet 402 is a common power outlet. The battery operation of the handsets 302 and tablet 402 provides additional portability of these devices.

Communication systems 500-600 can be distributed in retail stores of a service provider providing voice and data communication services to said devices, or third party retailers that sell electronic appliances.

Upon reviewing the aforementioned embodiments, it would be evident to an artisan with ordinary skill in the art that said embodiments can be modified, reduced, or enhanced without departing from the scope and spirit of the claims described below. For example, other combinations of short-range wireless access technologies can be applied between the base unit 202, the handsets 302, and the tablet 402. For instance, DECT can be replaced with Bluetooth or other suitable present or next generation short-range wireless access technologies. Additionally, the base unit 202 can be equipped with other broadband interfaces such as a high bandwidth fiber connections to the home.

Other suitable modifications can be applied to the present disclosure. Accordingly, the reader is directed to the claims section for a fuller understanding of the breadth and scope of the present disclosure.

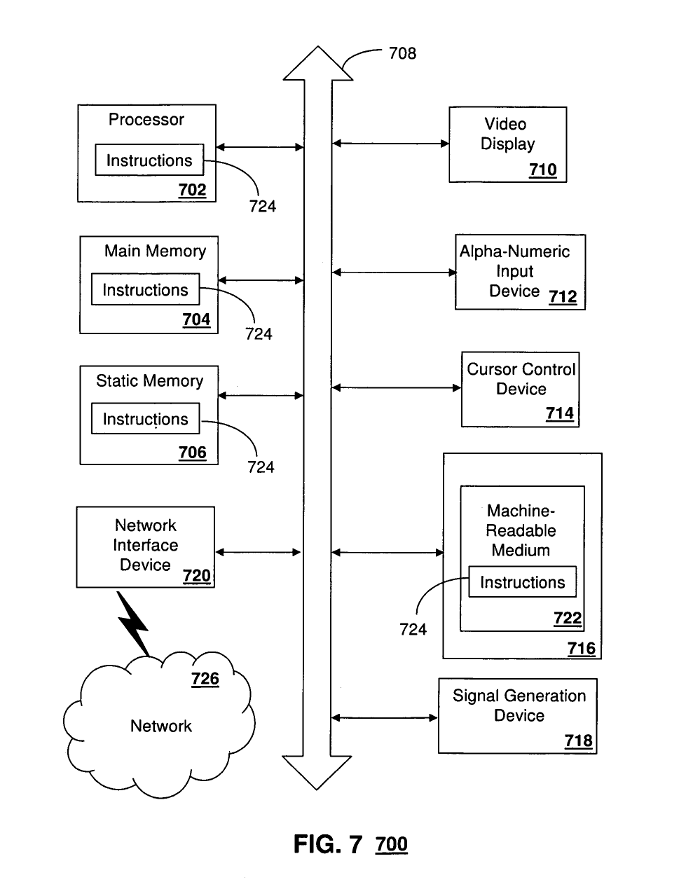

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A communication system, comprising:
a battery-operated communication device with a touch-sensitive display, the battery-operated communication device communicatively operating according to a Wireless Fidelity (WiFi) access protocol, or a Digital Enhanced Cordless Telecommunications (DECT) wireless access protocol;
one or more battery-operated handsets, each communicatively operating according to the DECT wireless access protocol; and
a base unit with a Public Switched Telephone Network (PSTN) port and an Ethernet port, wherein the PSTN port is for communicatively coupling to another PSTN port of a building, wherein the Ethernet port is for communicatively coupling to another Ethernet port, wherein the base unit communicatively operates according to the WiFi access protocol, or the DECT wireless access protocol, and
wherein the base unit is adapted to:
provide voice communication services to the battery-operated communication device by way of the PSTN port while communicatively coupled to the battery-operated communication device according to the DECT wireless access protocol,
provide data communication services to the battery-operated communication device by way of the Ethernet port while communicatively coupled to the battery-operated communication device according to the WiFi access protocol, and
provide voice communication services to each of the one or more battery-operated handsets by way of the PSTN port while communicatively coupled to each of the one or more battery-operated handsets according to the DECT wireless access protocol.

2. The communication system of claim 1, comprising a charger for the battery-operated communication device.

3. The communication system of claim 2, wherein the charger comprises:
a housing assembly in the form of a cradle for carrying the battery-operated communication device; and
a transformer for coupling to the housing assembly for supplying a DC charge to the battery-operated communication device while positioned in the cradle.

4. The communication system of claim 2, wherein the charger comprises a charging device for inductively charging the battery-operated communication device.

5. The communication system of claim 1, comprising a charger for each of the one or more battery-operated handsets.

6. The communication system of claim 5, wherein the charger comprises:
a housing assembly in the form of a cradle for carrying one of the one or more battery-operated handsets; and
a transformer for coupling to the housing assembly for supplying a DC charge to the battery-operated handset while positioned in the cradle.

7. The communication system of claim 5, wherein each charger comprises a charging device for inductively charging one of the one or more battery-operated handsets.

8. A communication system, comprising:
a battery-operated communication device with a touch-sensitive display, the battery-operated communication device communicatively operating according to a Wireless Fidelity (WiFi) access protocol, or a Digital Enhanced Cordless Telecommunications (DECT) wireless access protocol;
one or more battery-operated handsets, each communicatively operating according to the DECT wireless access protocol; and
a base unit comprising a voice services port, a WiFi routing device, and a modem communicatively coupled to the WiFi routing device, wherein the modem is for communicatively coupling to a data communications network, wherein the voice services port is for communicatively coupling to another voice services port, wherein the base unit communicatively operates according to the WiFi access protocol, or the DECT wireless access protocol, and
wherein the base unit is adapted to:
provide voice communication services to the battery-operated communication device by way of the voice services port while communicatively coupled to the battery-operated communication device according to the DECT wireless access protocol,
provide data communication services to the battery-operated communication device by way of the modem while communicatively coupled to the battery-operated communication device according to the WiFi access protocol, and
provide voice communication services to each of the one or more battery-operated handsets by way of the voice services port while communicatively coupled to the one or more battery-operated handsets according to the DECT wireless access protocol.

9. The communication system of claim 8, wherein the voice services port corresponds to one of a port conforming to a Public Switched Telephone Network (PSTN) protocol, a Voice over Internet Protocol (VoIP), or an IP Multimedia Subsystem (IMS) protocol.

10. The communication system of claim 8, comprising a charger for each of the battery-operated communication device, and the one or more battery-operated handsets.

11. The communication system of claim 10, wherein the charger comprises:
a housing assembly in the form of a cradle; and
a transformer for coupling to the housing assembly for supplying a DC charge to one of the battery-operated communication device or one of the one or more battery-operated handsets while positioned in the cradle.

12. The communication system of claim 10, wherein the charger comprises a charging device for inductively charging one of the battery-operated communication device or the one or more battery-operated handsets.

13. A communication system, comprising:
a battery-operated communication device with a touch-sensitive display, the battery-operated communication device communicatively operating according to a Wireless Fidelity (WiFi) access protocol, or a Digital Enhanced Cordless Telecommunications (DECT) wireless access protocol;
one or more battery-operated handsets, each communicatively operating according to the DECT wireless access protocol; and
a base unit with a voice services port and a data services port, the base unit communicatively operating according to the WiFi access protocol, and
wherein the base unit is adapted to:
provide voice communication services to the battery-operated communication device by way of the voice services port while communicatively coupled to the battery-operated communication device according to the WiFi access protocol,
provide data communication services to the battery-operated communication device by way of the data services port while communicatively coupled to the battery-operated communication device according to the WiFi access protocol, and
provide voice communication services to each of the one or more battery-operated handsets by way of the battery-operated communication device while the battery-operated communication device is communicatively coupled to the base unit according to the WiFi access protocol and communicatively coupled to each of the one or more battery-operated handsets according to the DECT wireless access protocol.

14. The communication system of claim 13, wherein the voice services port corresponds to one of a port conforming to a Public Switched Telephone Network (PSTN) protocol, a Voice over Internet Protocol (VoIP), or an IP Multimedia Subsystem (IMS) protocol, and wherein the data services port corresponds to one of an Ethernet port for coupling to another Ethernet port.

15. The communication system of claim 13, wherein the data port comprises a modem, and a WiFi routing device coupled to the modem, and wherein the modem is for communicatively coupling to a broadband service.

16. The communication system of claim 13, comprising a charger for each of the battery-operated communication device, and the one or more battery-operated handsets.

17. The communication system of claim 16, wherein the charger comprises:
a housing assembly in the form of a cradle; and
a transformer for coupling to the housing assembly for supplying a DC charge to one of the battery-operated communication device or the one or more battery-operated handsets while positioned in the cradle.

18. The communication system of claim 16, wherein the charger comprises a charging device for inductively charging one of the battery-operated communication device or the one or more battery-operated handsets.

19. A method, comprising distributing a combination of:
a battery-operated communication device with a touch-sensitive display, the battery-operated communication device communicatively operating according to a Wireless Fidelity (WiFi) access protocol, or a Digital Enhanced Cordless Telecommunications (DECT) wireless access protocol;
one or more battery-operated handsets, each communicatively operating according to the DECT wireless access protocol; and
a base unit with a voice services port and a data services port, and
wherein the base unit is adapted to:
provide voice communication services to the battery-operated communication device by way of the voice services port while communicatively coupled to the battery-operated communication device according to the DECT wireless access protocol,
provide data communication services to the battery-operated communication device by way of the data services port while communicatively coupled to the battery-operated communication device according to the WiFi access protocol, and
provide voice communication services to each of the one or more battery-operated handsets by way of the voice services port while communicatively coupled to each of the one or more battery-operated handsets according to the DECT wireless access protocol.

20. The method of claim 19, wherein the voice services port corresponds to one of a port conforming to a Public Switched Telephone Network (PSTN) protocol, a Voice over Internet Protocol (VoIP), or an IP Multimedia Subsystem (IMS) protocol, and wherein the data services port corresponds to one of an Ethernet port for coupling to another Ethernet port.

21. The method of claim 19, wherein the data port comprises a routing device for communicatively coupling to a broadband service.

22. The method system of claim 19, further comprising distributing a charger for each of the battery-operated communication device, and the one or more battery-operated handsets.

23. The method of claim 22, wherein the charger comprises:
a housing assembly in the form of a cradle; and
a transformer for coupling to the housing assembly for supplying a DC charge to one of the battery-operated communication device or the one or more battery-operated handsets while positioned in the cradle.

24. The method of claim 16, wherein the charger comprises a charging device for inductively charging one of the battery-operated communication device or the one or more battery-operated handsets.

25. The method of claim 19, comprising distributing the combination to one of mass market consumers and enterprise customers.

26. A communication system, comprising:
a battery-operated communication device with a touch-sensitive display, the battery-operated communication device communicatively operating according to one or more short-range wireless access protocols;
one or more battery-operated handsets, each communicatively operating according to one of the short-range wireless access protocols; and
a base unit with a voice services port and a data services port, and
wherein the base unit is adapted to:
provide voice communication services to the battery-operated communication device by way of the voice services port while communicatively coupled to the battery-operated communication device according to one of the short-range wireless access protocols,
provide data communication services to the battery-operated communication device by way of the data services port while communicatively coupled to the battery-operated communication device according to the same short-range wireless access protocol or another of the short-range wireless access protocols, and
provide voice communication services to each of the one or more battery-operated handsets by way of the voice services port while communicatively coupled to each of the one or more battery-operated handsets according to one of the short-range wireless access protocols.

27. The communication system of claim 26, wherein the one or more short-range wireless access protocols correspond to at least one of a Wireless Fidelity (WiFi) access protocol, a Digital Enhanced Cordless Telecommunications (DECT) wireless access protocol, or a Bluetooth wireless access protocol, and wherein the voice services port corresponds to a port conforming to one of a Public Switched Telephone Network (PSTN) protocol, a Voice over Internet Protocol (VoIP), an IP Multimedia Subsystem (IMS) protocol, and wherein the data services port corresponds to a broadband port.
